(19) United States
(12) Patent Application Publication
(10) Pub. No.: US 2025/0184253 A1
(43) Pub. Date: Jun. 5, 2025

(54) ANALYSIS DEVICE, ANALYSIS METHOD, AND STORAGE MEDIUM

(71) Applicant: NEC Corporation, Minato-ku, Tokyo (JP)

(72) Inventors: Yuki ASHINO, Tokyo (JP); Takashi HITANI, Tokyo (JP); Masahiro KARUBE, Tokyo (JP)

(73) Assignee: NEC Corporation, Minato-ku, Tokyo (JP)

(21) Appl. No.: 18/844,083

(22) PCT Filed: Mar. 16, 2022
(86) PCT No.: PCT/JP2022/011937

§ 371 Date: Sep. 5, 2024

(51) Int. Cl. H04L 43/0852

(52) U.S. Cl. CPC H04L 43/0852

(57) ABSTRACT

An analysis device includes at least one memory configured to store instructions, and at least one processor configured to execute the instructions to calculate, based on the difference in arrival times of communication packets between a first communication device and a second communication device connected via a communication network, characteristic information on the arrival time of each of the different communication paths in the communication network.

### TECHNICAL FIELD

This invention relates to an analysis device, an analysis method, and a storage medium.

### BACKGROUND ART

Communication devices installed at different locations and connected to each other via a communication network can communicate with no particular knowledge that the communication paths comprising the communication network are being switched with the passage of time. Switching communication paths may be done at the will of the telecommunication provider operating the communication network. For example, a telecommunication provider reassigns communications between communication devices that have been communicating via one communication path to another communication path in order to support maintenance of relay devices and other devices that make up the communication network. This maintains communication between communication devices even in a case where switching is occurring in the communication network.

Related technology is disclosed in Patent Document 1. Patent Document 1 discloses technology for a device equipped with an RTT calculation portion as a means of calculating the RTT of a signal transmitted and received between a client device and a server device by extracting a plurality of samples of this signal, a variation judgment portion as a means of determining the variation of the RTT calculated by the RTT calculation portion, and a sample number adjustment portion as a means of adjusting the sample number based on the judgment result of this variation judgment portion.

### PRIOR ART DOCUMENTS

### Patent Document

Patent Document 1: Japanese Unexamined Patent Application, First Publication No. 2010-28684.

### SUMMARY OF THE INVENTION

### Problems to be Solved by the Invention

Here, there is a need for a technology that can easily identify in a case where a communication path switchover is occurring.

It is therefore the purpose of this invention to provide an analysis device, an analysis method, and a recording medium that solves the aforementioned problem.

### Means for Solving the Problem

According to the first example aspect of the invention, the analysis device is provided with a characteristic information specifying means that, based on the difference in arrival times of communication packets between a first communication device and a second communication device connected via a communication network, specifies characteristic information on the arrival time of each of the different communication paths in the communication network.

According to the second example aspect of the invention, the analysis method, based on the difference in arrival times of communication packets between a first communication device and a second communication device connected via a communication network, specifies characteristic information on the arrival time of each of the different communication paths in the communication network.

According to the third example aspect of the invention, the program causes a computer of an analysis device to function as a characteristic information specifying means that, based on the difference in arrival times of communication packets between a first communication device and a second communication device connected via a communication network, specifies characteristic information on the arrival time of each of the different communication paths in the communication network.

### Effect of Inventions

According to the present invention, it is easy to ascertain that switching between communication paths is occurring using only communication data.

### BRIEF DESCRIPTION OF THE DRAWINGS

FIG. 1 is a diagram that shows a communication device equipped with the analysis device according to the present example embodiment and a communication network to which the communication device is connected.

FIG. 2 is a first diagram that shows the response time according to the time between communication devices according to the example embodiment.

FIG. 3 is a second diagram that shows the response time according to the time between communication devices according to the example embodiment.

FIG. 4 is a diagram that illustrates the delay related to the response at the destination communication device according to the example embodiment.

FIG. 5 is a diagram that shows an example of characteristic information of communication in a certain communication path according to the example embodiment.

FIG. 6 is a diagram that shows an example of characteristic information of communication for each of multiple communication paths according to the example embodiment.

FIG. 7 is a functional block diagram of the analysis device according to the first example embodiment.

FIG. 8 is a diagram that shows the processing flow of the analysis device according to the first example embodiment.

FIG. 9 is a diagram that shows the measurement results and characteristic information of communication according to the first example embodiment.

FIG. 10 is a first diagram that shows the process of specifying characteristic information for each communication path according to the first example embodiment.

FIG. 11 is a second figure that shows the process of specifying characteristic information for each communication path according to the first example embodiment.

FIG. 12 is a functional block diagram of the analysis device according to the second example embodiment.

FIG. 13 is a functional block diagram of the analysis device according to the third example embodiment.

FIG. 14 is a functional block diagram of the analysis device according to the fourth example embodiment.

FIG. 15 is a diagram that shows the output information of the analysis device according to the fourth example embodiment.

FIG. 16 is a diagram that shows the analysis system according to the fifth example embodiment.

FIG. 17 is a diagram that shows the analysis system according to the sixth example embodiment.

FIG. 18 is a diagram that shows the minimum configuration of the analysis device.

FIG. 19 is a diagram that shows the processing flow of an analysis device with the minimum configuration.

FIG. 20 is a block diagram schematically showing an example hardware configuration of a computing and processing device that can realize the analysis device according to each example embodiment.

### EXAMPLE EMBODIMENT

The following is a description of a communication network to which is connected a communication device equipped with an analysis device according to one example embodiment of the invention, with reference to the drawings.

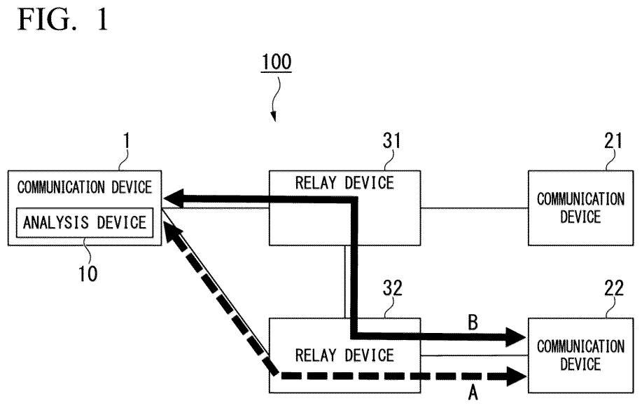

FIG. 1 is a diagram that shows a communication device equipped with the analysis device according to the present example embodiment and a communication network to which the communication device is connected. An analysis system 100 is composed of the communication device equipped with the analysis device and a communication device of the communication destination. In the analysis system 100 shown by FIG. 1, a communication device 1 equipped with an analysis device 10 is connected to other communication devices 21 and 22 via a relay device 31 and a relay device 32. The other communication devices 21 and 22 shall be collectively referred to as communication device 2. The relay devices 31 and 32 shall be collectively referred to as relay device 3. In a case where communicating with the communication device 21, the communication device 1 communicates via the relay device 31 or the relay device 32. In a case where communicating with the communication device 22, the communication device 1 communicates via the relay device 31 or the relay device 32. In a case where the communication device 1 and communication devices 21 and 22 communicate, whether the relay device that relays the communication is the relay device 31 or the relay device 32 depends on the settings of the communication provider that manages the communication network between the communication device 1 and the communication devices 21 and 22. For example, if the distance between the communication device 1 and the communication devices 21 and 22 is a long distance, such as several hundred kilometers, the communication providers managing the communication network may be different, and the communication network will be composed of many relay devices 3. In this case, the communication providers that manages the relay devices 3 will also be different. Here, in the communication network connecting the communication device 1 and the communication device 22 shown in FIG. 1, for example, there are two communication paths: the first communication path A, in which relay device 32 relays communication between the communication device 1 and the communication device 22, and the second communication path B, in which relay devices 31 and 32 relay communication between the communication device 1 and the communication device 22.

Similarly, in the communication network connecting the communication device 1 and the communication device 21 shown in FIG. 1, there are two communication paths: the first communication path in which the relay device 31 relays communication between the communication device 1 and the communication device 21, and the second communication path in which the relay devices 32 and 31 relay communication between the communication device 1 and the communication device 21. The greater the number of relay devices 3, the greater the number of communication paths that can be used in the communication network between the communication device 1 and the communication devices 21 and 22. Normally, users of the communication device 1 and users of the communication devices 21 and 22 are not informed or aware of which communication path is used in the communication network connecting those two communication devices.

Here, it is sometimes desirable, for security reasons, to be able to detect whether the communication path has been switched or not in communications between such communication devices.

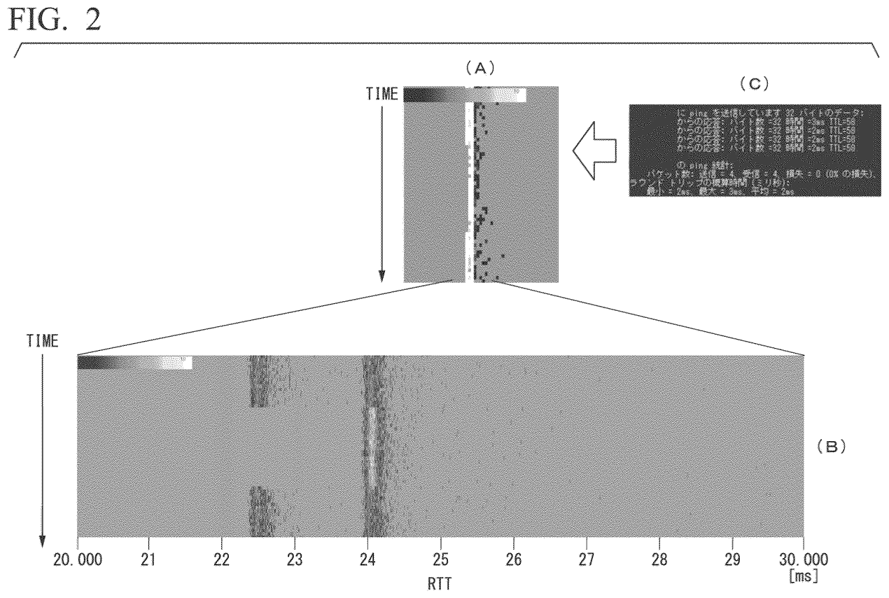

FIG. 2 is the first diagram showing the differences in response time over time between communicating devices that communicate. Suppose that a ping is sent from the communication device 1 to the communication device 21, and the measurement of the response time RTT (Round Trip Time) until the ping response from the communication device 21 is received by communication device 1 (FIG. 2(C)) is performed over a long time, such as 6 hours. FIG. 2 shows a graph with the vertical axis representing each time from the measurement start time to the measurement end time and the horizontal axis representing the response time RTT. In this graph, the average response time for each ping in a unit time, such as 2 minutes, is plotted as a dot, and the color of the dot represents the number of ping responses received in that response time. In FIG. 2(A) with a narrower horizontal axis, the RTT appears as almost a straight line, indicating that the RTT is similar throughout the 6 hours, but in a case where the horizontal axis is expanded with higher resolution, it becomes evident that there are variations in RTT occurring within the six-hour timeframe. Differences in response time RTT correspond to the differences in arrival time RTT of communication packets between two communication devices connected through a communication network. The differences in RTT indicate that the communication path length has changed along the way, i.e., the communication path has changed, as shown in FIG. 2. This analysis device of the present example embodiment detects such differences in communication paths.

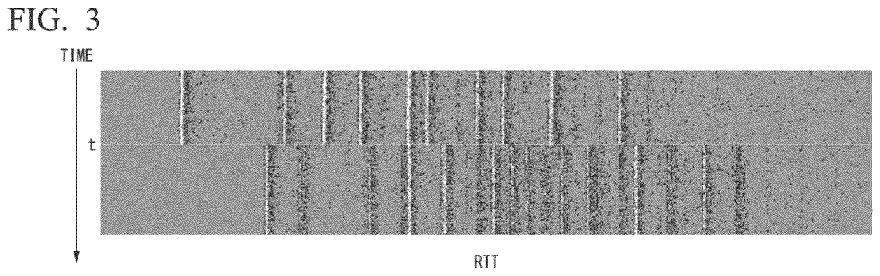

FIG. 3 is the second diagram showing the differences in response time over time between communicating devices that communicate. The graph shown in FIG. 3 shows the relationship between each time from the measurement start time to the measurement end time (vertical axis) and the response time RTT (horizontal axis) in a case where there are many relay devices 3 comprising the communication network and many communication paths are switched during communication between the communication devices. As FIG. 3 shows, differences occur in the stripe patterns at a certain time t. This indicates that communication between communication devices is still taking place before time t using multiple communication paths, and communication between the communication devices is still taking place after time t using the multiple communication paths. Furthermore, FIG. 3 shows that the multiple communication paths used are different before and after time t. The user of the communication device 1 equipped with the analysis device 10 seeks to ascertain the usage of these communication paths and the switching of communication paths.

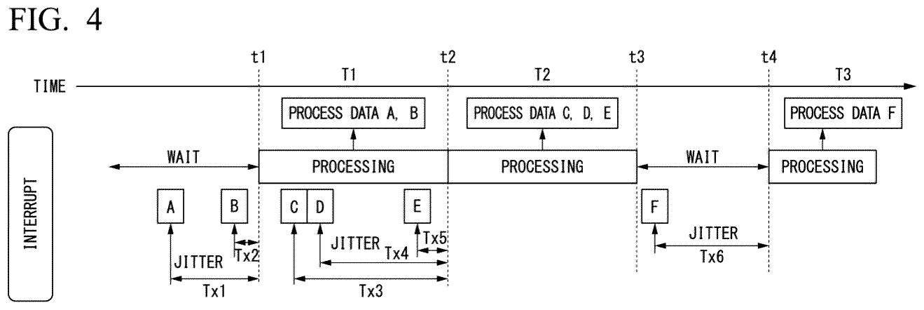

FIG. 4 is a diagram that illustrates the delay related to the response at the destination communication device according to the example embodiment.

At the destination communication device 2 (e.g., communication devices 21 and 22), a response is returned based on the communication data from the communication device 1. The timing of this response varies with time due to interrupt processing and the like in the communication device 2.

For example, as shown in FIG. 4, interrupt processing occurs in the communication device 2. As an example, the communication device 2 receives communication data A, B, C, D, E, and F from the communication device 1 in this order. Assume that the communication data A, B, C, D, E, and F are pings. The communication device 2 performs processing related to the communication data collectively in predetermined time units. Then the communication device 2 waits until the processing start time t1 to perform the response processing of the communication data A and B, and then performs the response processing during the time T1 from the processing start time t1 to the next processing start time t2. In other words, in the communication device 2, jitter Tx1 is generated until processing start time t1 for response processing for communication data A and jitter Tx2 is generated until processing start time t1 for response processing for communication data B. The communication device 2 performs a response (ping response) to the communication device 1 for communication data A and communication data B in time T1 in the order in which they were received respectively.

The communication device 2, upon receiving the communication data C, D, and E during time T1, waits until the next processing start time t2 to perform the response processing of those communication data C, D, and E. The communication device 2 waits until the processing start time t2 to perform the response processing of the communication data C, D, and E, and then performs the response processing during the time T2 from that processing start time t2 to the next processing start time t3. In other words, in the communication device 2, jitter Tx3 occurs until the processing start time t2 for response processing for communication data C, jitter Tx4 occurs until the processing start time t2 for response processing for communication data D, and jitter Tx5 occurs until the processing start time t2 for response processing for communication data E. The communication device 2 performs a response (ping response) to the communication device 1 for the communication data C, D, and E in time T2 in the order in which they were received, respectively.

The communication device 2, upon receiving the communication data F at a time after the time T2, waits until the next processing start time t4 to perform the response processing of the communication data F. The communication device 2 waits until the processing start time t4 to perform the response processing of the communication data F, and then performs the response processing during the time T3 from that processing start time t4 to the next processing start time. In other words, jitter Tx6 is generated in the communication device 2 until the processing start time t4 of the response process for the communication data F. The communication device 2 performs a response (ping response) to the communication device 1 for communication data F in time T3.

Each of the above mentioned jitter Tx1 to Tx6 is different. Therefore, the response to the ping sent by the communication device 1 to the destination communication device 2 is delayed as the jitter time to the ping sent by communication device 1 increases. This causes a discrepancy in the response time from the transmission time of the ping or other communication data sent until the response is received in the communication device 1. The response time can also be caused by factors other than the above jitter time at the destination communication device 2. For example, factors such as the performance of the network interface card, kernel performance, and operating state of the application software used by the communication device 2 can delay the transmission of the response signal by the communication device 2. Characteristic information on the communication response time, generated based on the response time discrepancies described above, shows the unique characteristic of each communication device 2. The response time RTT between communication devices is an example of the arrival time between such communication devices.

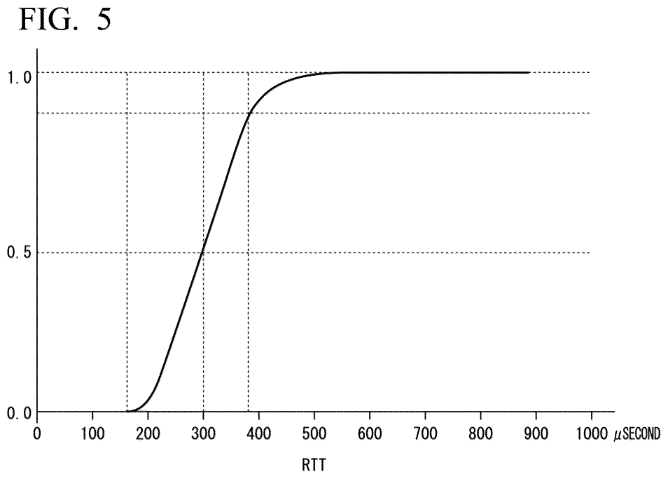

FIG. 5 shows an example of characteristic information on the response time of a certain communication path according to this system. The characteristic information (signature) on the response time of the communication path shown in FIG. 5 shows the relationship between the response time of a ping sent by the communication device 1 to the communication device 2 and the cumulative relative frequency in a case where one ping transmission is taken as the transmission unit. In other words, the characteristic information on the response time of the communication path in the present example embodiment represents the cumulative relative frequency distribution of the response time RTT from the time the communication device 1 sends a ping to the time it receives the ping response from the communication device 2, as shown in FIG. 5. In the example in FIG. 5, the response time RTT in a case where the communication device 1 sends a ping to the communication device 2 indicates the characteristic of a distribution ranging from 170 μs to about 600 μs. The response time RTT varies depending on the distance between the communication device 1 and the communication device 2. In this characteristic information on the response time of the communication path, the growth of the cumulative relative frequency per unit time is small in the initial and final periods of the response time RTT indicated by the characteristic information, and the growth of the cumulative relative frequency per unit time is large near the center.

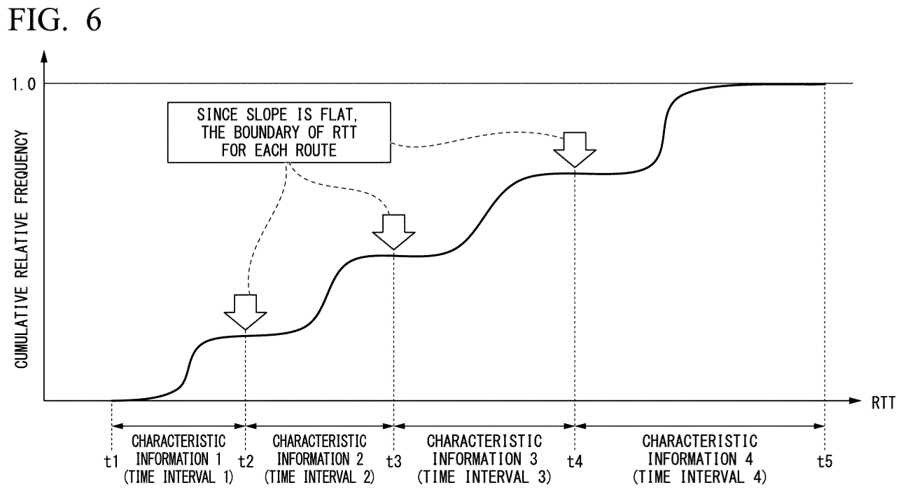

FIG. 6 shows an example of characteristic information on the response time of a plurality of communication paths according to the present example embodiment. As described in FIG. 2, suppose that a ping is sent from the communication device 1 to the communication device 21, and the measurement of the response time RTT (Round Trip Time) until the ping response from the communication device 21 is received by the communication device 1 (FIG. 2(C)) is performed over a long time, such as 6 hours. During this time, in a case where the communication path switches due to the operation of the relay device 3, which constitutes the communication network between the communication device 1 and the communication device 2, the difference in response time can be observed as shown in FIGS. 2 and 3. Then, using the measurement results showing this difference in response time, a graph of the cumulative relative frequency distribution of response time RTT (Round Trip Time) as illustrated in FIG. 5 is generated, resulting in the graph shown in FIG. 6. Similar to FIG. 5, FIG. 6 also shows the cumulative relative frequency distribution of the response time RTT (Round Trip Time).

In a case where the communication path of a ping's communication packet changes, the communication characteristics shown in FIG. 2 can be seen in several different response time RTT time intervals, as shown in FIG. 5. Because of changes in the distance of the communication path, differences in response times in FIG. 2 appear in the time intervals of different response time RTT. Characteristic information 1 regarding the response time in time interval 1 from time t1 to time t2, characteristic information 2 regarding the response time in time interval 2 from time t2 to time t3, characteristic information 3 regarding the response time in time interval 3 from time t3 to time t4, and characteristic information 4 regarding the response time in time interval 5 from time t4 to time t5 respectively show characteristic information on the response time in the different communication paths. In other words, the characteristic information shown in FIG. 6 indicates characteristic information on the response time (arrival time) of each communication path.

As explained in FIG. 5, for the characteristic information on response time, the growth of accumulated relative frequencies is smaller in the initial and final periods of the response time RTT indicated by the characteristic information. Therefore, in a case where characteristic information on response times of multiple communication paths is obtained, using the response time RTT with a small increase in cumulative relative frequencies or response time RTT with a small number of occurrences for calculating cumulative relative frequencies, it is possible to extract from the characteristic information on response times of multiple communication paths the characteristic information on the response time of each communication path. Then, the analysis device 10 included in the communication device 1 sends a ping from the communication device 1 to the communication device 21, and based on the result of measuring the response time RTT (Round Trip Time) until the communication device 1 receives the ping response from the communication device 21 over a long period of time, extracts the characteristic information on the response time of the communication path. The analysis device 10 can notify of anomalies upon identifying a communication path switch or other event based on characteristic information on the response time of the communication path.

### First Example Embodiment

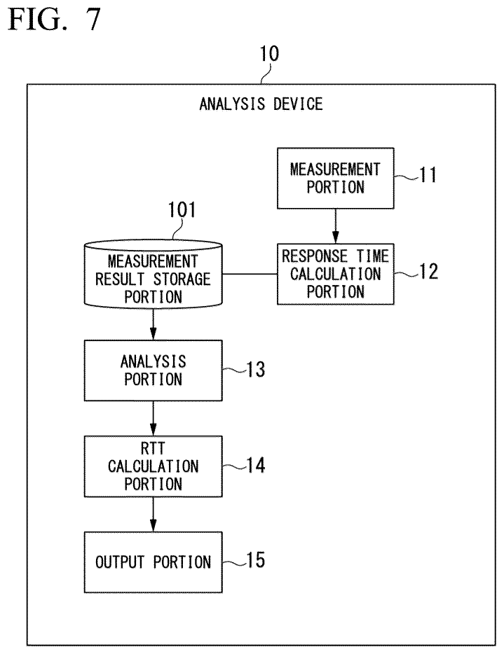

FIG. 7 is a functional block diagram of the analysis device according to the first example embodiment.

The analysis device 10 performs the functions of a measurement portion 11, a response time calculation portion 12, an analysis portion 13, a RTT calculation portion 14, and an output portion 15. The analysis device 10 is equipped with a measurement result storage portion 101.

The measurement portion 11 sends a communication packet to the destination communication device 2 and measures the arrival time of the packet. A ping packet is a form of communication packet.

The response time calculation portion 12 calculates the arrival time based on the arrival time of the communication packet and records it in the measurement result storage portion 101.

The analysis portion 13 calculates characteristic information on the response time for each of the different communication paths in the communication network based on the differences in arrival times of communication packets sent from the communication device 1 to the communication device 2. The characteristic information on a response time indicates the relationship between the arrival time of a communication packet sent by the communication device 1 to the communication device 2 described above and the cumulative relative frequency of such arrival times. The response time RTT described above is a form of arrival time. In addition, in a case where the time span of the arrival times of multiple communication packets is divided into predetermined time units, the analysis portion 13 calculates the frequency of occurrence for each such time unit. Then, the analysis portion 13 specifies characteristic information on the response time classified by the arrival time in which the frequency of occurrence continues to be less than a predetermined threshold as the characteristic information on the response time of one communication path.

The RTT calculation portion 14 calculates the representative arrival time (response time RTT) for each communication path.

The output portion 15 outputs the calculation results.

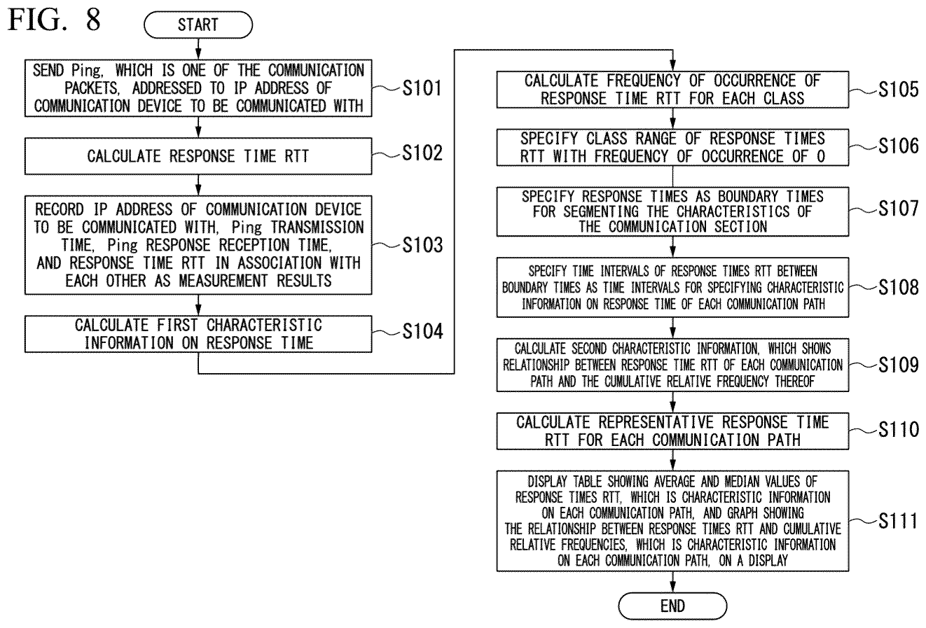

FIG. 8 shows the processing flow of the analysis device.

Hereinbelow, the communication device 1 communicates with the communication device 22, and the analysis device 10 analyzes the communication network between the communication device 1 and the communication device 22. First, the measurement portion 11 sends a ping, which is one of the communication packets, addressed to the IP address of the communication device 22 to be communicated with (Step S101). In a case where the communication device 21 receives the ping, it sends a ping response to the communication device 1. The measurement portion 11 of the communication device 1 acquires information on the received ping response. The measurement portion 11 outputs the transmission time of the ping and the reception time of the ping response to the response time calculation portion 12. The measurement portion 11 continues to send a ping once per second, for example, for a predetermined period of time from the measurement start time to the measurement end time. The predetermined time from the measurement start time to the measurement end time may be a long time, for example, 6 hours. The measurement portion 11 outputs the transmission time of the ping sent during the predetermined time period and the reception time of the ping response to the response time calculation portion 12 in sequence. The response time calculation portion 12 calculates the response time RTT, which indicates the interval between the transmission time of a ping and the reception time of the ping response (Step S102). The response time calculation portion 12 records the IP address of the destination communication device 2, the ping transmission time, the ping response reception time, and the response time RTT in association with each other as the measurement results (Step S103). As a result, the measurement results for a predetermined time (6 hours) are recorded in the measurement result storage portion 101.

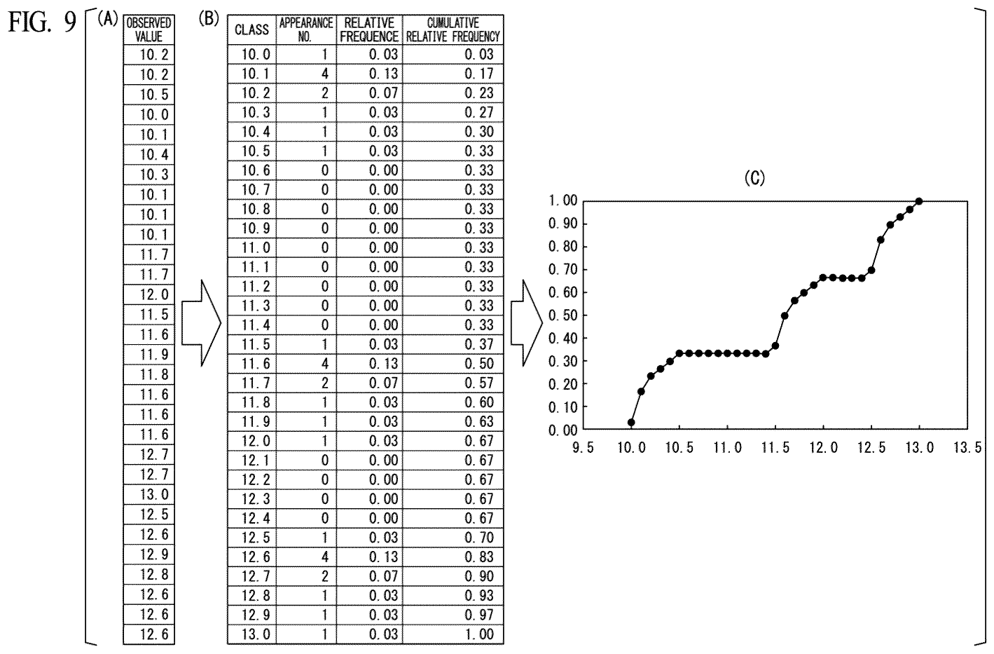

FIG. 9 shows the measurement results and characteristic information on response time according to the first example embodiment.

As shown in FIG. 9(A), for example, the response time RTT of the measurement results is mostly distributed between around 10.2 ms and 12.6 ms. The distribution of response times RTT of the measurement results may exceed the range shown in FIG. 9(A), but the analysis portion 13 may utilize information of the responses in a range containing a predetermined percentage, such as 90%, of the response times RTT of the communication packets. The analysis portion 13 retrieves such measurement results from the measurement result storage portion 101. Based on the measurement results (FIG. 9(A)), the analysis portion 13 calculates first characteristic information on the response time (Step S104). The first characteristic information is shown in FIGS. 9(B) and 9(C). The analysis portion 13 calculates the frequency of occurrence of each response time RTT according to each class corresponding to an interval of 0.1 ms in the time range of the response times RTT indicated by the first characteristic information (Step S105). This process is a form of processing to calculate the frequency of occurrence for each time unit in a case where the time span of the arrival time of multiple communication packets is divided into predetermined time units. The analysis portion 13 calculates the relative and cumulative relative frequencies based on the frequency of occurrence of the response time RTT (Step S104). The relationship between the response time RTT and cumulative relative frequency thereof can be expressed as shown in FIG. 9(C).

The analysis portion 13 may change this class according to the degree of variation of the response time RTT. If the seconds interval corresponding to each class is too wide, it is difficult to show that a difference in response time has occurred, as shown in FIG. 2(A). If the seconds interval corresponding to each class is too narrow, it is difficult to show that a difference in response time occurred as shown in FIG. 2(B). Therefore, the analysis portion 13 may set the class so that the number of occurrences of 0 is within the range of a predetermined value a or more and less than a predetermined value β. The analysis portion 13 may repeat the calculation of the frequency of occurrence while changing the class interval corresponding to the span of the response time RTT, and set the classes so that the number of zero occurrences is within the range of a predetermined value a or more and less than a predetermined value β. Alternatively, other processes may be used to set the class. Alternatively, the analysis portion 13 may set a predetermined class for the resulting measured response time RTT.

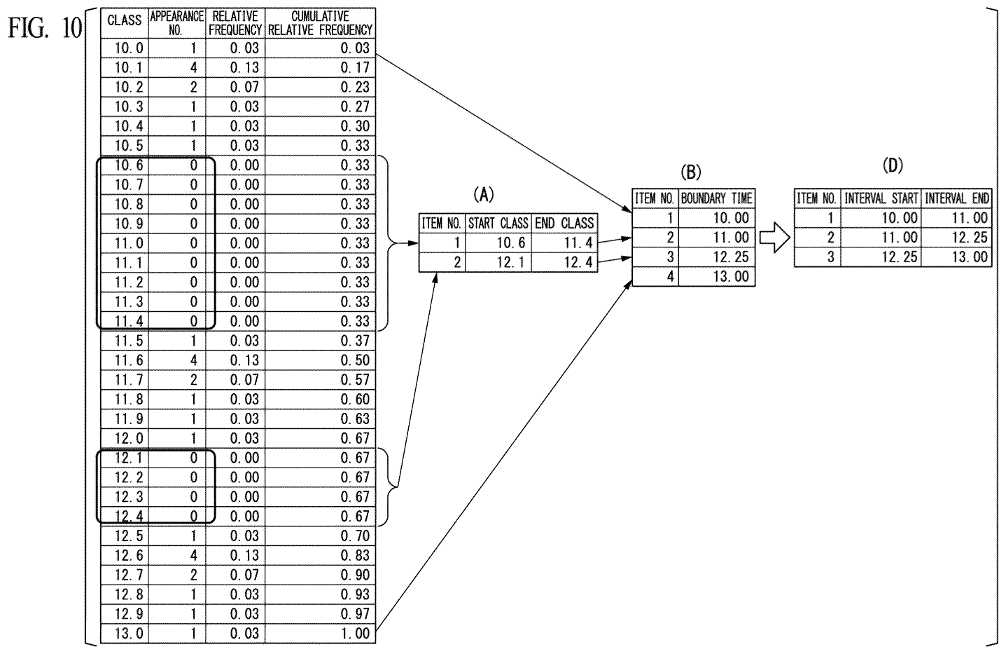

FIG. 10 is the first diagram showing the process of specifying characteristic information on the response time for each communication path according to the first example embodiment.

The analysis portion 13, in a case where calculating characteristic information on the response time as shown in FIG. 9(B), identifies the range of response times RTT in which the frequency of occurrence in the characteristic information remains below the threshold value. The class range of response times RTT with a frequency of occurrence of 0 or less, i.e., with a frequency of occurrence of 0, is specified in the present example embodiment (Step S106). The threshold value for the frequency of occurrence may be a value other than zero (e.g., 1 or 2) for the purpose of specifying a range of low growth in the cumulative relative frequency, as shown in FIG. 6. In the case of the example in FIG. 10, the analysis portion 13 specifies a class range corresponding to response times RTT of 10.6 ms to 11.4 ms and a class range corresponding to response times RTT of 12.1 ms to 12.4 ms (FIG. 10(A)). These class ranges indicate the ranges corresponding to the response times RTTs in the graph in FIG. 9(C), where the growth of the relative cumulative frequency per unit time is small and almost flat. This range corresponds to the time range that includes the time that separates the characteristic information on the response time of different communication paths.

As shown in FIG. 10(B), the analysis portion 13 specifies 11.0 ms as a boundary time for segmenting the characteristic of the communication section, this value being the median, among the first time range in the range of response times RTTs with a frequency of occurrence of 0, of the start class of the range indicating the earliest 10.6 ms, and the end class of the range indicating 11.4 ms. Similarly, the analysis portion 13 specifies 12.25 milliseconds as a boundary time for segmenting the characteristic of the communication section, this value being the median, among the second time range in the range of response times RTTs with a frequency of occurrence of 0, of the start class of the range indicating the earliest 12.1 milliseconds, and the end class of the range indicating 12.4 milliseconds. The analysis portion 13 also specifies the response time RTT corresponding to the class with the lowest value among the classes (10.0 ms) and the response time RTT corresponding to the class with the highest value among the classes (13.0 ms) as the boundary times for segmenting the characteristics of the communication section (Step S107).

Using the specified boundary times (10.0 ms, 11.0 ms, 12.25 ms, 13.0 ms), the analysis portion 13 specifies the time intervals of response times RTT between those boundary times as the time intervals for specifying characteristic information on response time for each communication path (Step S108). In other words, the analysis portion 13 identifies 10.0 ms to 11.0 ms as the time interval that shows characteristic information on the response time of the first communication path in the communication network connecting the communication device 1 and the communication device 2 (item 1 in FIG. 10(D)). The analysis portion 13 also identifies 11.1 ms to 12.25 ms as the time interval that shows characteristic information on the response time of the second communication path in the communication network connecting the communication device 1 and the communication device 2 (item 2 in FIG. 10(D)). The analysis portion 13 also identifies 12.26 ms to 13.0 ms as the time interval that shows characteristic information on the response time of the third communication path in the communication network connecting the communication device 1 and the communication device 2 (item 3 in FIG. 10(D)).

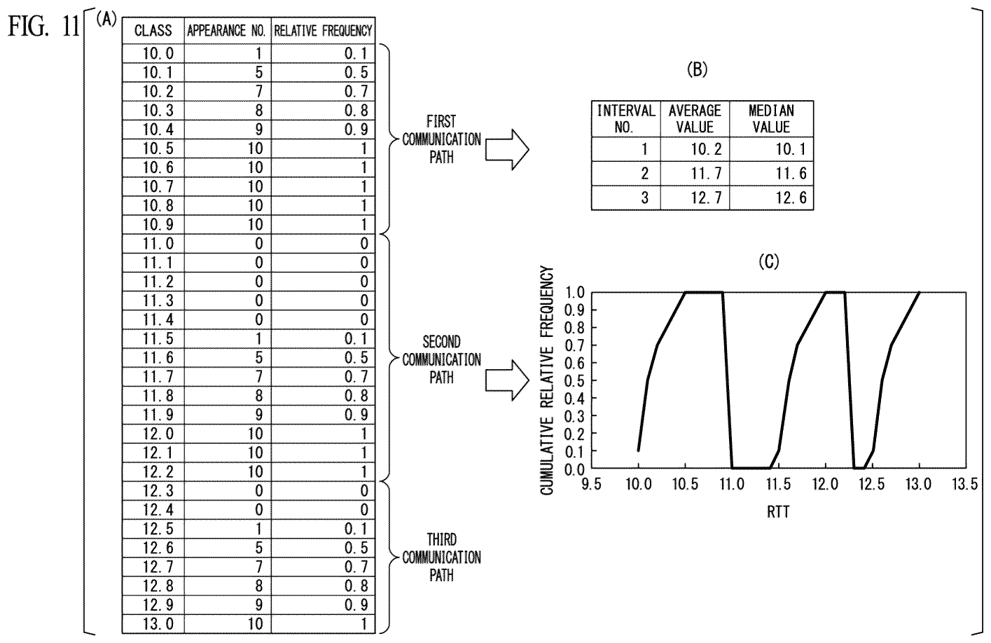

FIG. 11 is the second diagram showing the process of specifying characteristic information on the response time for each communication path according to the first example embodiment.

The analysis portion 13 calculates the second characteristic information (FIG. 11(A)), which shows the relationship between the response time RTT of each communication path and the cumulative relative frequency thereof, based on the characteristic information on the response time of each communication path (Step S109). This second characteristic information indicates that the cumulative relative frequency for each class of response time RTT is 0 to 1 for each time range of response time RTT of each communication path (FIG. 11(A)).

The analysis portion 13 calculates the representative response time RTT for each of the one or more communication paths indicated by the second characteristic information (Step S110). In other words, the analysis portion 13 calculates the average (10.2 ms) or median (10.1 ms) of the response times RTT of the communication packets included in the time range of the response time RTT between the time interval boundary times of the response time RTT (10.0 ms, 11.0 ms), which is characteristic information on the response time of the first communication path, as the representative response time RTT of the first communication path (FIG. 11 (B)). Similarly, the analysis portion 13 calculates the average (11.7 ms) or median (11.6 ms) of the response times RTT of the communication packets included in the time range of the response time RTT between the time interval boundary times of the response time RTT (11.0 ms, 12.25 ms), which is characteristic information on the response time of the second communication path, as the representative response time RTT of the second communication path (FIG. 11(B)). Similarly, the analysis portion 13 calculates the average (12.7 ms) or median (12.6 ms) of the response times RTT of the communication packets included in the time range of the response time RTT between the time interval boundary times of the response time RTT (12.25 ms, 13.0 ms), which is characteristic information on the response time of the second communication path, as the representative response time RTT of the third communication path (FIG. 11(B)).

The analysis portion 13 also outputs the calculated characteristic information on the response time of each of the first to third communication paths to the output portion 15. Based on the calculated characteristic information on the response time of each of the first to third communication paths, the output portion 15 displays a table (FIG. 11(B)) showing the average and median values of the response times RTT, which is characteristic information on each communication path, and a graph (FIG. 11(C)) showing the relationship between the response times RTT and the cumulative relative frequencies, which is characteristic information on each communication path, on a display (Step S111). The output portion 15 displays on a display the characteristic information shown in FIG. 9 (FIG. 9(B)) and a graph showing the relationship between the response times RTT and cumulative relative frequencies generated based on the characteristic information (FIG. 9(C)). The output portion 15 may be used to transmit the information displayed to other devices.

With the above process, the analysis device 10 calculates and outputs the characteristic information on the response time of each of the different communication paths in the communication network based on the differences in the response time of communication packets sent from the communication device 1 to the communication device 2 connected via the communication network. At this time, the analysis device 10 outputs information on representative values (average and median values) of the response times RTT of each communication path as characteristic information, as well as a graph indicating the switching of communication paths of communication packets in the communication network. This allows the user to easily ascertain the switching of communication paths of communication packets sent from the communication device 1 to the communication device 2.

### Second Example Embodiment

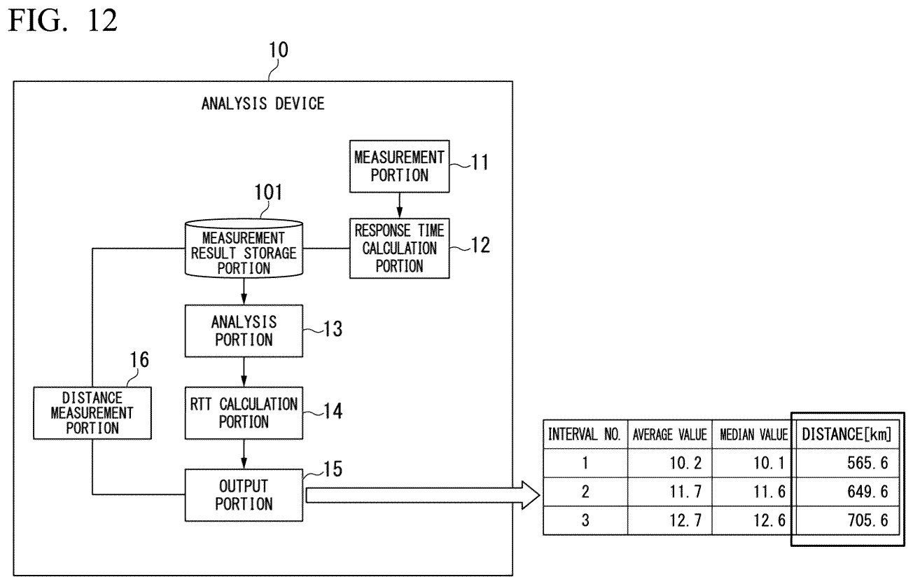

FIG. 12 is a functional block diagram of the analysis device according to the second example embodiment.

In addition to each of the functions shown in FIG. 7, the analysis device 10 may perform the function of a distance measuring portion 16. The distance measuring portion 16 calculates the distance of the communication path between the communication device and the communication destination.

The distance measuring portion 16 obtains the medium speed Vm of the communication data of the transmission medium between the communication device 1 and the destination communication device 2 from a memory or the like. The transmission medium of the communication network connecting the communication device 1 and the communication device 2 is known. The medium speed Vm of that transmission medium is also known in advance. The distance measuring portion 16 calculates the distance of the communication path between the communication device 1 and the communication device 2 by multiplying the medium speed Vm by (response time RTT÷2). The distance measuring portion 16 may calculate the distance multiple times based on the response time RTT of the transmission time of one ping and the reception time of the ping response, and determine the average of these times as the distance between the communication device 1 and the communication device 2. Alternatively, the distance measuring portion 16 may calculate the distance between the communication device 1 and the communication device 2 by multiplying the medium speed Vm by (response time RTT/2), with the average or median value of the response time RTT of each communication path calculated by the RTT calculation portion 14 serving as the response time RTT. The distance measuring portion 16 outputs the distance for each communication path to the output portion 15. The output portion 15 may display the distance for each communication path in association with the mean or median of the response time RTT, which is characteristic information on the response time of each communication path, in the table shown in FIG. 11(B).

According to the process of the second example embodiment described above, the analysis device 10 can calculate the distance between communication devices by each communication path analyzed by the analysis portion 13.

### Third Example Embodiment

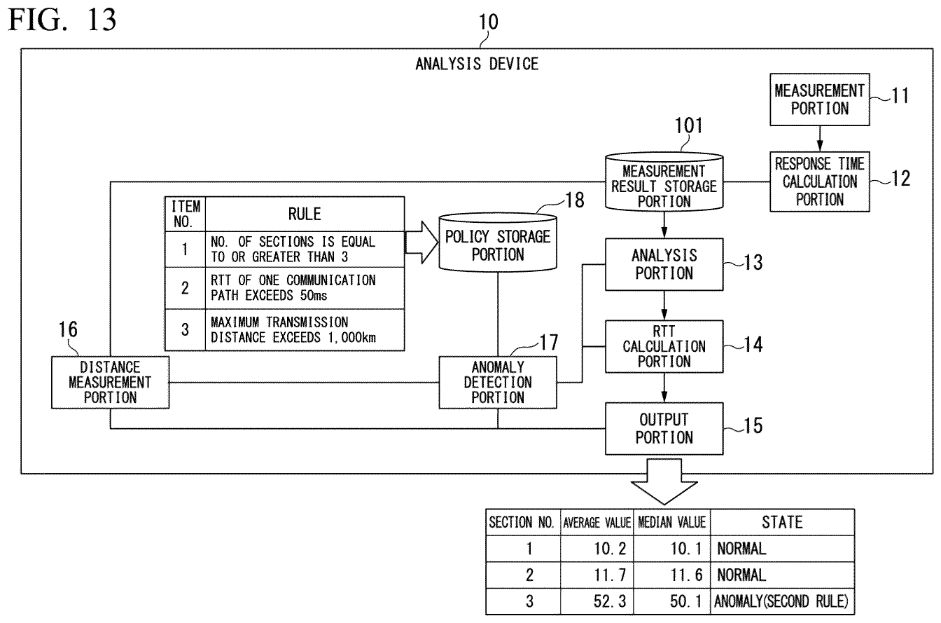

FIG. 13 is a functional block diagram of the analysis device according to the third example embodiment.

In addition to the functions shown in FIG. 7 and FIG. 12, the analysis device 10 may further perform the function of an anomaly detection portion 17. In this case, the analysis device 10 is equipped with a policy storage portion 18.

The anomaly detection portion 17 determines anomalies in the communication path concerned based on the characteristic information on the response time of the communication path. The anomaly detection portion 17 may determine anomalies in the communication path concerned based on differences in characteristic information on the response time of the communication path. The anomaly detection portion 17 may determine anomalies in the communication path concerned based on a representative value (average or median value) of the arrival time of the communication path.

More specifically, the policy storage portion 18 records anomaly detection rules. For example, a first rule, which determines an anomaly if the number of communication paths is equal to or greater than three, a second rule, which determines an anomaly if the response time RTT of one communication path exceeds 50 ms, and a third rule, which determines an anomaly if the transmission distance exceeds 1000 km, are recorded.

The anomaly detection portion 17 obtains characteristic information on the response time of each communication path from the analysis portion 13. The anomaly detection portion 17 calculates the number of communication paths in the measured time based on the number of representative response times RTT and other information contained in that characteristic information. The anomaly detection portion 17 compares that number with the number of communication paths indicated by the first rule, and if the number of communication paths in the measured time is greater than or equal to the number of communication paths indicated by the first rule, it makes a determination of an anomaly and outputs to the output portion 15 an ID indicating the first rule. The output portion 15 displays information indicating the anomaly and an ID indicating the rule used to determine the anomaly.

The anomaly detection portion 17 obtains the representative response time RTT for each communication path from the RTT calculation portion 14. The anomaly detection portion 17 compares that representative response time RTT with the response time RTT indicated by the second rule, and if the response time RTT obtained from the RTT calculation portion 14 is longer than the response time RTT indicated by the second rule, it makes a determination of an anomaly and outputs to the output portion 15 an ID indicating the second rule. The output portion 15 displays information indicating the anomaly and an ID indicating the rule used to determine the anomaly.

The anomaly detection portion 17 obtains the distance of each communication path from the distance measuring portion 16. The anomaly detection portion 17 compares that distance with the distance indicated by the third rule, and if the distance obtained from the distance measuring portion 16 is greater than or equal to the distance indicated by the third rule, it makes a determination of an anomaly and outputs to the output portion 15 an ID indicating the third rule. The output portion 15 displays information indicating the anomaly and an ID indicating the rule used to determine the anomaly.

According to the process of the third example embodiment, the analysis device 10 can provide notification of anomalies, etc. based on the status of changes in the communication path. This allows users to identify anomalies caused by changes in the communication paths that make up the communication network between communication devices.

### Fourth Example Embodiment

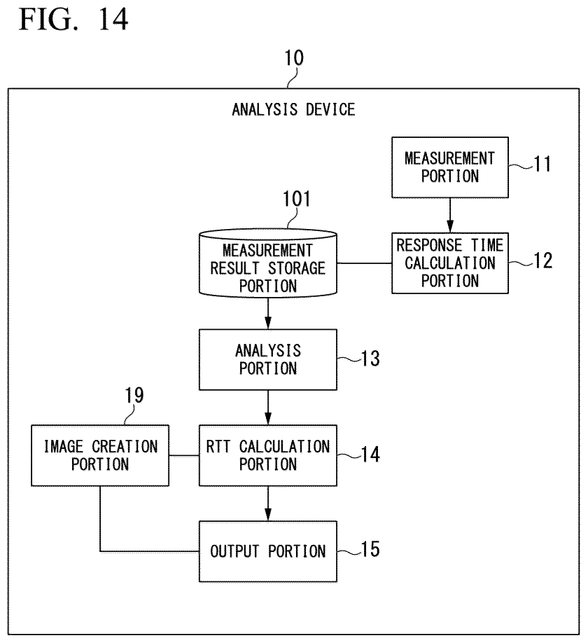

FIG. 14 is a functional block diagram of the analysis device according to the fourth example embodiment.

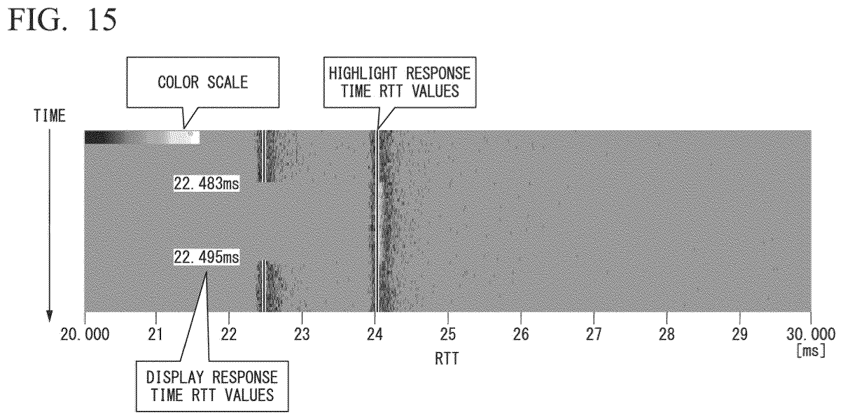

FIG. 15 is a diagram that shows the output information of the analysis device according to the fourth example embodiment.

In addition to the functions shown in FIGS. 7, 12, and 13, the analysis device 10 may further perform the function of an image creation portion 19. The image creation portion 19 generates and outputs an image (FIG. 15) showing the response time according to the time between communication devices shown in FIGS. 2 and 3. The image creation portion 19 may display in this image a numerical value of the response time RTT for each communication path, may display in this graph a vertical line indicating the average time of the ping response time, and may superimpose on the graph a color scale indicating the magnitude of the number of ping responses received in that response time.

### Fifth Example Embodiment

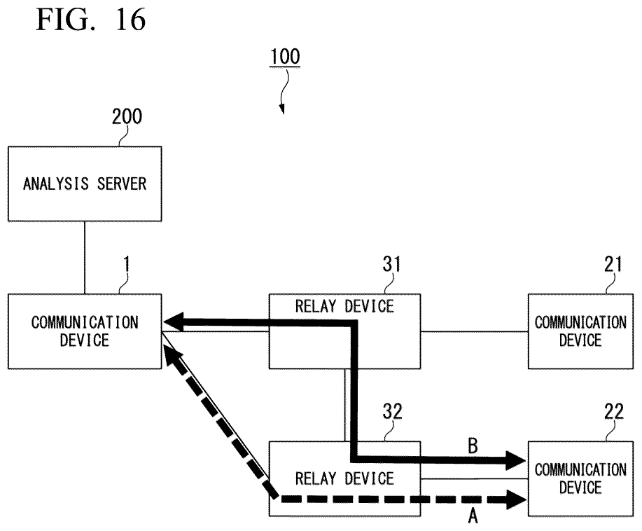

FIG. 16 is a diagram that shows the analysis system according to the fifth example embodiment.

In each of the above-mentioned example embodiments, the analysis device 10 in the communication device 1 performs each of the above-mentioned processes. However, an analysis server 200 that is communicatively connected to the communication device 1 may be equipped with the functions of the analysis device 10. The analysis server 200 may then acquire information on the measurement results of the measurement portion 11 of the communication device 1 and perform the processing of each functional part of the other example embodiments described above.

### Sixth Example Embodiment

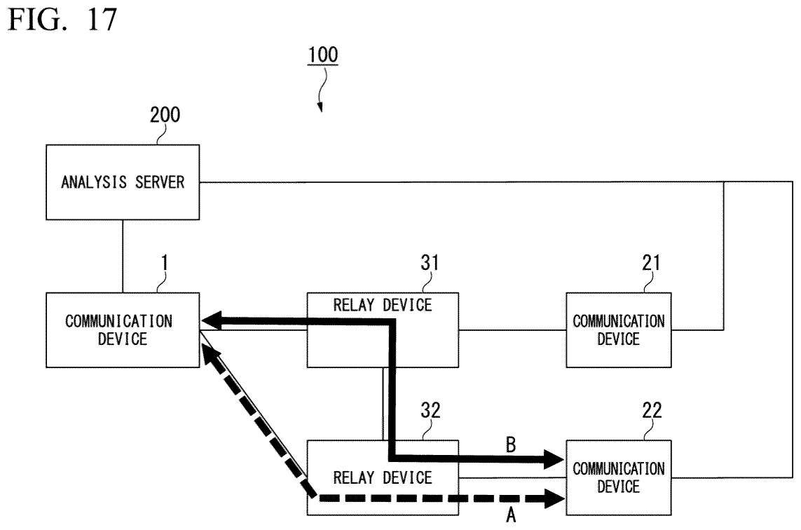

FIG. 17 is a diagram that shows the analysis system according to the sixth example embodiment.

In the first through fifth example embodiments described above, characteristic information on response times of multiple communication paths is calculated based on the response time RTT. However, instead of the response time RTT, the analysis device 10 and analysis server 200 may use arrival time T of a ping packet from the communication device 1 to the communication device 2 to perform the same analysis process as in each of the above example embodiments. The arrival time T of a ping packet from the communication device 1 to the communication device 2 also varies with the load state of the relay device 3 on the way. The analysis device 10 or the analysis server 200 may then obtain information on the arrival time T from the communication device 2 (21, 22) that is the communication destination, to perform the processing of each functional part of the other example embodiments described above.

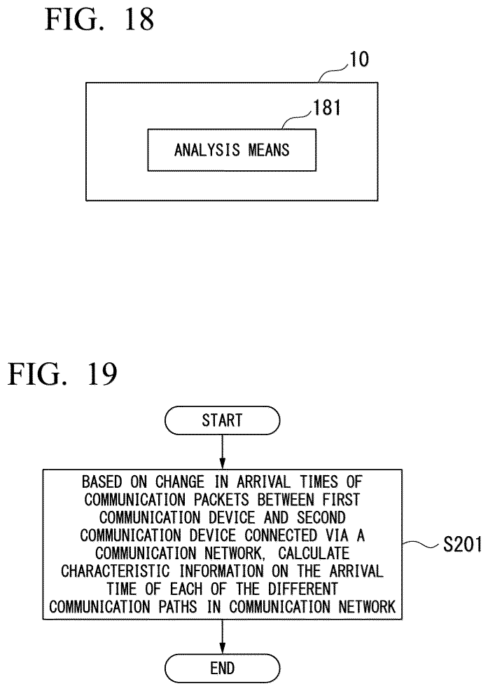

FIG. 18 is a diagram that shows the minimum configuration of the analysis device.

FIG. 19 is a diagram that shows the processing flow of an analysis device with the minimum configuration.

The analysis device 10 is equipped with, at least, an analysis means 181.

The analysis means 181, based on the difference in arrival times of communication packets between a first communication device and a second communication device connected via a communication network, calculates characteristic information on the arrival time of each of the different communication paths in the communication network (Step S201).

### Hardware Configuration

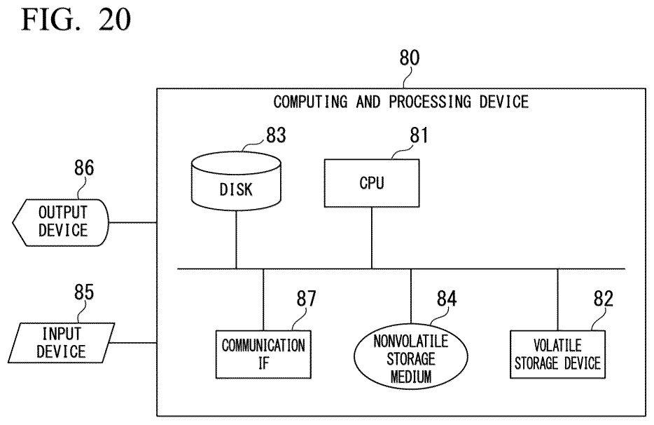

FIG. 20 is a block diagram schematically showing an example hardware configuration of a computing and processing device that can realize the analysis device for each example embodiment of the present invention.

This following describes an example of a hardware resource configuration that realizes the analysis device 10 using a single computing and processing device (information processing device, computer). However, this analysis device 10 may be physically or functionally realized using at least two computing and processing devices. This analysis device 10 may be realized as a dedicated device.

The computing and processing device 80 has a central processing unit (CPU) 81, a volatile storage device 82, a disk 83, a nonvolatile storage medium 84, and a communication interface (hereinafter referred to as “communication IF”) 87. The computing and processing device 80 may be connectable to an input device 85 and an output device 86. The computing and processing device 80 can send and receive information to and from other computational processors and other communication devices via the communication IF 87.

The nonvolatile recording medium 84 is a computer-readable medium, e.g., Compact Disc, Digital Versatile Disc. The nonvolatile recording medium 84 may be a universal serial bus memory (USB memory), a solid state drive (solid state drive), and the like. The nonvolatile recording medium 84 retains the relevant program without supplying power and allows it to be carried around. The nonvolatile recording medium 84 is not limited to the media described above. Instead of the nonvolatile recording medium 84, the relevant program may be carried via the communication IF 87 and the communication network.

The volatile storage device 82 is readable by a computer and can temporarily store data. The volatile storage device 82 is a memory such as DRAM (dynamic random access memory), SRAM (static random access memory), and the like.

In other words, the CPU 81 copies the software program (computer program, hereinbelow simply referred to as “the program”) that is stored on the disk 83 to the volatile storage device 82 in a case where it is executed, and executes arithmetic operations. The CPU 81 reads the data necessary for program execution from the volatile storage device 82. In a case where a display is required, the CPU 81 displays the output results to the output device 86. In a case where entering a program from the outside, the CPU 81 reads the program from the input device 85. The CPU 81 interprets and executes the analysis program (FIG. 4 or FIG. 5) in the volatile storage device 82 corresponding to the function (processing) represented by each part shown in FIG. 2 (or FIG. 3). The CPU 81 executes the processes described in each of the above mentioned example embodiments of the invention. In other words, in such cases, the various example embodiments of the present invention can be perceived as being made possible by the relevant analysis program. Furthermore, each example embodiment of the present invention can also be perceived as being realized by a computer-readable, nonvolatile recording medium on which the analysis program is recorded.

In conclusion, the present invention has been described using the above-mentioned example embodiments as exemplary examples. However, the present invention is not limited to the example embodiments described above. In other words, the invention can be applied in various ways within the scope of the invention that can be understood by those skilled in the art.

Some or all of the above example embodiments may also be described as, but not limited to, the following supplementary notes.

### Supplementary Note 1

An analysis device provided with an analysis means that, based on the difference in arrival times of communication packets between a first communication device and a second communication device connected via a communication network, calculates characteristic information on the arrival time of each of the different communication paths in the communication network.

### Supplementary Note 2

The analysis device according to Supplementary Note 1, wherein the analysis means calculates a representative value of the arrival time of each of the different communication paths based on the arrival time of each of the communication paths.

### Supplementary Note 3

The analysis device according to Supplementary Note 1 or Supplementary Note 2, wherein the analysis means
calculates an occurrence frequency of each such time unit in a case where the time span of the arrival times obtained by multiple transmissions of communication packets is divided into predetermined time units, and
calculates information on the arrival time of each communication packet divided by the arrival time in which the occurrence frequency continues to be less than a predetermined threshold as the characteristic information on the arrival time of one communication path.

### Supplementary Note 4

The analysis device according to any one of supplementary notes 1 to 3, provided with an anomaly determination means that, based on the characteristic information on the arrival time of the communication path, determines an anomaly of the communication path.

### Supplementary Note 5

The analysis device according to any one of supplementary notes 1 to 3, provided with an anomaly determination means that, based on a difference in the characteristic information on the arrival time of the communication path indicating the relationship between the arrival time of each time unit in a case where the time span of the arrival times from multiple transmissions of communication packets is divided into predetermined time units, and the cumulative relative frequency of each the time units, determines an anomaly of the communication path.

### Supplementary Note 6

The analysis device according to any one of supplementary notes 1 to 3, provided with an anomaly determination means that, based on a representative value of the arrival time of the communication path, determines an anomaly of the communication path.

### Supplementary Note 7

The analysis device according to any one of supplementary notes 1 to 6, wherein the arrival time is the arrival time calculated by the difference between the transmission time in a first communication device of a communication packet sent from the first communication device to a second communication device and the reception time in the first communication device of the communication packet that the second communication device responded to the first communication device.

### Supplementary Note 8

The analysis device according to any one of supplementary notes 1 to 6, wherein the arrival time is the arrival time calculated by the difference between the transmission time in a first communication device of a communication packet sent from the first communication device to a second communication device and the reception time at which the second communication device received the communication packet.

### Supplementary Note 9

An analysis method that, based on the difference in arrival times of communication packets between a first communication device and a second communication device connected via a communication network, calculates characteristic information on the arrival time of each of the different communication paths in the communication network.

### Supplementary Note 10

A storage medium that stores a program for causing a computer of an analysis device to function as
an analysis means that, based on the difference in arrival times of communication packets between a first communication device and a second communication device connected via a communication network, calculates characteristic information on the arrival time of each of the different communication paths in the communication network.

### Description of Reference Signs

1, 2, 21, 22 Communication device
3, 31, 32 Relay device
10 Analysis device
11 Measurement portion
12 Response time calculation portion
13 Analysis portion
14 RTT calculation portion
15 Output portion
16 Distance measuring portion
17 Anomaly detection portion
18 Policy storage portion
19 Image creation portion
100 Analysis system
200 Analysis server

What is claimed is:

1. An analysis device comprising:
at least one memory configured to store instructions; and
at least one processor configured to execute the instructions to calculate,
based on the difference in arrival times of communication packets between a first communication device and a second communication device connected via a communication network, characteristic information on the arrival time of each of the different communication paths in the communication network.

2. The analysis device according to claim 1, wherein the at least one processor is configured to calculate a representative value of the arrival time of each of the different communication paths based on the arrival time of each of the communication paths.

3. The analysis device according to claim 1, wherein the at least one processor is configured to:
calculate an occurrence frequency of each such time unit in a case where the time span of the arrival times obtained by multiple transmissions of communication packets is divided into predetermined time units, and
calculate information on the arrival time of each communication packet divided by the arrival time in which the occurrence frequency continues to be less than a predetermined threshold as the characteristic information on the arrival time of one communication path.

4. The analysis device according to claim 1, wherein the at least one processor is configured to determine, based on the characteristic information on the arrival time of the communication path, an anomaly of the communication path.

5. The analysis device according to claim 1, wherein the at least one processor is configured to determine, based on a difference in the characteristic information on the arrival time of the communication path indicating the relationship between the arrival time of each time unit in a case where the time span of the arrival times from multiple transmissions of communication packets is divided into predetermined time units, and the cumulative relative frequency of each the time units, determines an anomaly of the communication path.

6. The analysis device according to claim 1, wherein the at least one processor is configured to determine, based on a representative value of the arrival time of the communication path, an anomaly of the communication path.

7. The analysis device according to claim 1, wherein the arrival time is the arrival time calculated by the difference between the transmission time in a first communication device of a communication packet sent from the first communication device to a second communication device and the reception time in the first communication device of the communication packet that the second communication device responded to the first communication device.

8. The analysis device according to claim 1, wherein the arrival time is the arrival time calculated by the difference between the transmission time in a first communication device of a communication packet sent from the first communication device to a second communication device and the reception time at which the second communication device received the communication packet.

9. An analysis method comprising calculating, based on the difference in arrival times of communication packets between a first communication device and a second communication device connected via a communication network, characteristic information on the arrival time of each of the different communication paths in the communication network.

10. A non-transitory storage medium that stores a program for causing a computer of an analysis device to execute calculating,
based on the difference in arrival times of communication packets between a first communication device and a second communication device connected via a communication network, characteristic information on the arrival time of each of the different communication paths in the communication network.

11. The analysis method according to claim 9, wherein the calculating the characteristic information includes calculating a representative value of the arrival time of each of the different communication paths based on the arrival time of each of the communication paths.

12. The analysis method according to claim 9, wherein the calculating the characteristic information includes:
calculating an occurrence frequency of each such time unit in a case where the time span of the arrival times obtained by multiple transmissions of communication packets is divided into predetermined time units, and
calculating information on the arrival time of each communication packet divided by the arrival time in which the occurrence frequency continues to be less than a predetermined threshold as the characteristic information on the arrival time of one communication path.

13. The analysis method according to claim 9, further comprising determining, based on the characteristic information on the arrival time of the communication path, an anomaly of the communication path.

14. The analysis method according to claim 9, further comprising determining, based on a difference in the characteristic information on the arrival time of the communication path indicating the relationship between the arrival time of each time unit in a case where the time span of the arrival times from multiple transmissions of communication packets is divided into predetermined time units, and the cumulative relative frequency of each the time units, an anomaly of the communication path.

15. The analysis method according to claim 9, further comprising determining, based on a representative value of the arrival time of the communication path, an anomaly of the communication path.

16. The analysis method according to claim 9, wherein the arrival time is the arrival time calculated by the difference between the transmission time in a first communication device of a communication packet sent from the first communication device to a second communication device and the reception time in the first communication device of the communication packet that the second communication device responded to the first communication device.

17. The analysis method according to claim 9, wherein the arrival time is the arrival time calculated by the difference between the transmission time in a first communication device of a communication packet sent from the first communication device to a second communication device and the reception time at which the second communication device received the communication packet.

18. The non-transitory storage medium according to claim 10, wherein the calculating the characteristic information includes calculating a representative value of the arrival time of each of the different communication paths based on the arrival time of each of the communication paths.

19. The non-transitory storage medium according to claim 10, wherein the calculating the characteristic information includes:
calculating an occurrence frequency of each such time unit in a case where the time span of the arrival times obtained by multiple transmissions of communication packets is divided into predetermined time units, and
calculating information on the arrival time of each communication packet divided by the arrival time in which the occurrence frequency continues to be less than a predetermined threshold as the characteristic information on the arrival time of one communication path.

20. The non-transitory storage medium according to claim 10, wherein the program further causes the computer to execute determining, based on the characteristic information on the arrival time of the communication path, an anomaly of the communication path.

21. The non-transitory storage medium according to claim 10, wherein the program further causes the computer to execute determining, based on a difference in the characteristic information on the arrival time of the communication path indicating the relationship between the arrival time of each time unit in a case where the time span of the arrival times from multiple transmissions of communication packets is divided into predetermined time units, and the cumulative relative frequency of each the time units, an anomaly of the communication path.

22. The non-transitory storage medium according to claim 10, wherein the program further causes the computer to execute determining, based on a representative value of the arrival time of the communication path, an anomaly of the communication path.

23. The non-transitory storage medium according to claim 10, wherein the arrival time is the arrival time calculated by the difference between the transmission time in a first communication device of a communication packet sent from the first communication device to a second communication device and the reception time in the first communication device of the communication packet that the second communication device responded to the first communication device.

24. The non-transitory storage medium according to claim 10, wherein the arrival time is the arrival time calculated by the difference between the transmission time in a first communication device of a communication packet sent from the first communication device to a second communication device and the reception time at which the second communication device received the communication packet.
